(19) United States
(12) Patent Application Publication
(10) Pub. No.: US 2024/0345854 A1
(43) Pub. Date: Oct. 17, 2024

(54) TASK CREATION METHOD AND APPARATUS, ELECTRONIC DEVICE AND STORAGE MEDIUM

(71) Applicant: Beijing Zitiao Network Technology Co., Ltd., Beijing (CN)

(72) Inventors: Danni WU, Beijing (CN); Jian SUN, Beijing (CN)

(21) Appl. No.: 18/752,142

(22) Filed: Jun. 24, 2024

Related U.S. Application Data
(63) Continuation of application No. PCT/CN2022/138408, filed on Dec. 12, 2022.

(30) Foreign Application Priority Data
Dec. 24, 2021 (CN) 202111599126.1

(51) Int. Cl. G06F 9/451; H04L 51/08

(52) U.S. Cl. CPC G06F 9/451; H04L 51/08

(57) ABSTRACT

The present disclosure relates to a task creation method and apparatus, and an electronic device and a storage medium. The method comprises: acquiring a trigger operation of a user on a target task in a task catalog, wherein the target task has a target attachment; and in response to the trigger operation, displaying, on the basis of a permission of the user, a task viewing panel corresponding to the target task, wherein the task viewing panel has a first presentation style and a second presentation style regarding the target attachment, and the displaying, on the basis of the permission of the user, the task viewing panel corresponding to the target task comprises: displaying the task viewing panel on the basis of the permission of the user and by means of the first presentation style or the second presentation style.

### CROSS-REFERENCE TO RELATED APPLICATIONS

The present application is a continuation of International application No. PCT/CN2022/138408 filed on Dec. 12, 2022, which based on and claims the priority to the Chinese Patent Application No. 202111599126.1 filed on Dec. 24, 2021, and entitled “TASK CREATION METHOD AND APPARATUS, ELECTRONIC DEVICE AND STORAGE MEDIUM”, the disclosure of which is incorporated by reference herein in its entirety.

### TECHNICAL FIELD

The present disclosure relates to the field of computer technologies, and in particular, to a task creation method and apparatus, an electronic device and a storage medium.

### BACKGROUND

With the development of an instant messaging tool, the instant messaging tool is no longer limited to a function of sending instant messages, but is expanded to other functions, such as sending an online document, online editing the online document, and converting session content into a task.

In the related art, when a user converts session content to a task in a session interface of the instant messaging tool, a file in the session content is displayed in the task in a form of a session record, making it inconvenient for the user to refer to file content related to the task when viewing the task.

### SUMMARY

The present disclosure provides a task creation method and apparatus, an electronic device and a storage medium, capable of presenting an attachment in a task to a user on the basis of a permission of the user, making it convenient for the user to read content of the attachment.

In a first aspect, the present disclosure provides a task creation method, comprising:
acquiring a trigger operation of a user on a target task in a task catalog, wherein the target task has a target attachment; and
in response to the trigger operation, displaying, on the basis of a permission of the user, a task viewing panel corresponding to the target task, wherein the task viewing panel has a first presentation style and a second presentation style regarding the target attachment, and the displaying, on the basis of the permission of the user, the task viewing panel corresponding to the target task comprises: displaying the task viewing panel on the basis of the permission of the user and by means of the first presentation style or the second presentation style.

In a second aspect, an embodiment of the present disclosure provides a task creation apparatus, comprising:
an acquisition module configured to acquire a trigger operation of a user on a target task in a task catalog, wherein the target task has a target attachment;
a display module configured to, in response to the trigger operation, display, on the basis of a permission of the user, a task viewing panel corresponding to the target task, wherein the task viewing panel has a first presentation style and a second presentation style regarding the target attachment, and the displaying, on the basis of the permission of the user, the task viewing panel corresponding to the target task comprises: displaying the task viewing panel on the basis of the permission of the user and by means of the first presentation style or the second presentation style.

In a third aspect, an embodiment of the present disclosure provides an electronic device, comprising: a processor configured to execute a computer program stored in a memory, the computer program, when executed by the processor, implementing steps of any of the methods provided in the first aspect.

In a fourth aspect, an embodiment of the present disclosure provides a computer-readable storage medium having thereon stored a computer program which, when executed by a processor, implements steps of any of the methods provided in the first aspect.

In a fifth aspect, an embodiment of the present disclosure provides a computer program product which, when running on a computer, causes the computer to perform steps of any of the methods provided in the first aspect.

In a sixth aspect, the present disclosure provides a computer program comprising instructions which, when executed by a processor, cause the processor to perform steps of any of the methods provided in the first aspect.

### BRIEF DESCRIPTION OF THE DRAWINGS

The accompanying drawings herein, which are incorporated in and constitute a part of this specification, illustrate embodiments consistent with the present disclosure and, together with the description, serve to explain the principles of the present disclosure.

In order to more clearly illustrate technical solutions in the embodiments of the present disclosure or the related art, the drawings that need to be used in the description of the embodiments or related art will be briefly described below, and it is obvious that for one of ordinary skill in the art, other drawings can be obtained according to these drawings without paying out creative efforts.

FIG. 1A is a schematic diagram of a display screen provided by the present disclosure;

FIG. 1B is a schematic diagram of another display screen provided by the present disclosure;

FIG. 1C is a schematic diagram of yet another display screen provided by the present disclosure;

FIG. 2A is a schematic diagram of yet another display screen provided by the present disclosure;

FIG. 2B is a schematic diagram of yet another display screen provided by the present disclosure;

FIG. 2C is a schematic diagram of yet another display screen provided by the present disclosure;

FIG. 3A is a schematic diagram of yet another display screen provided by the present disclosure;

FIG. 3B is a schematic diagram of yet another display screen provided by the present disclosure;

FIG. 4 is a schematic flow diagram of a task creation method provided by the present disclosure;

FIG. 5A is a schematic diagram of yet another display screen provided by the present disclosure;

FIG. 5B is a schematic diagram of yet another display screen provided by the present disclosure;

FIG. 5C is a schematic diagram of yet another display screen provided by the present disclosure;

FIG. 6 is a schematic flow diagram of another task creation method provided by the present disclosure;

FIG. 7 is a schematic flow diagram of yet another task creation method provided by the present disclosure;

FIG. 8 is a schematic flow diagram of yet another task creation method provided by the present disclosure;

FIG. 9 is a schematic flow diagram of yet another task creation method provided by the present disclosure;

FIG. 10 is a schematic flow diagram of yet another task creation method provided by the present disclosure;

FIG. 11A is a schematic diagram of yet another display screen provided by the present disclosure;

FIG. 11B is a schematic diagram of yet another display screen provided by the present disclosure;

FIG. 12 is a schematic flow diagram of yet another task creation method provided by the present disclosure;

FIG. 13 is a schematic flow diagram of yet another task creation method provided by the present disclosure;

FIG. 14A is a schematic diagram of yet another display screen provided by the present disclosure;

FIG. 14B is a schematic diagram of yet another display screen provided by the present disclosure;

FIG. 15 is a schematic flow diagram of yet another task creation method provided by the present disclosure;

FIG. 16A is a schematic diagram of yet another display screen provided by the present disclosure;

FIG. 16B is a schematic diagram of yet another display screen provided by the present disclosure;

FIG. 17 is a schematic flow diagram of yet another task creation method provided by the present disclosure;

FIG. 18 is a schematic flow diagram of yet another task creation method provided by the present disclosure

FIG. 19 is a schematic diagram of a task creation apparatus provided by an embodiment of the present disclosure.

### DETAILED DESCRIPTION

In order that the above objectives, features and advantages of the present disclosure can be more clearly understood, the solutions of the present disclosure will be further described below. It should be noted that, without conflict, the embodiments of the present disclosure and features in the embodiments may be combined with each other.

In the following description, numerous specific details are set forth in order to provide a thorough understanding of the present disclosure, but the present disclosure may be implemented in other ways different from those described herein; and it is obvious that the embodiments disclosed in the description are only some of the embodiments of the present disclosure, rather than all of them.

The technical solutions of the present disclosure are applicable to a terminal device, wherein the terminal device can be a computer, a tablet, a mobile phone or other intelligent electronic devices, and the like. The terminal device has a display screen, wherein the display screen can be a touch screen or a non-touch screen; for the terminal device with a touch screen, a user can enable an interaction operation with the terminal device through a gesture, finger or touch tool (such as a stylus). For the terminal device without a touch screen, the user can enable the interaction operation with the terminal device through an external device (such as a mouse or a keyboard).

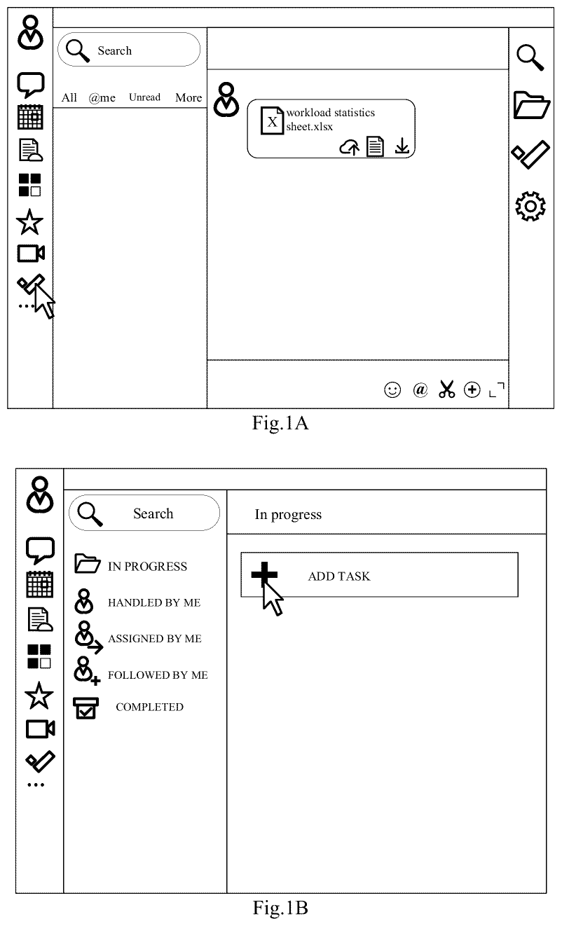

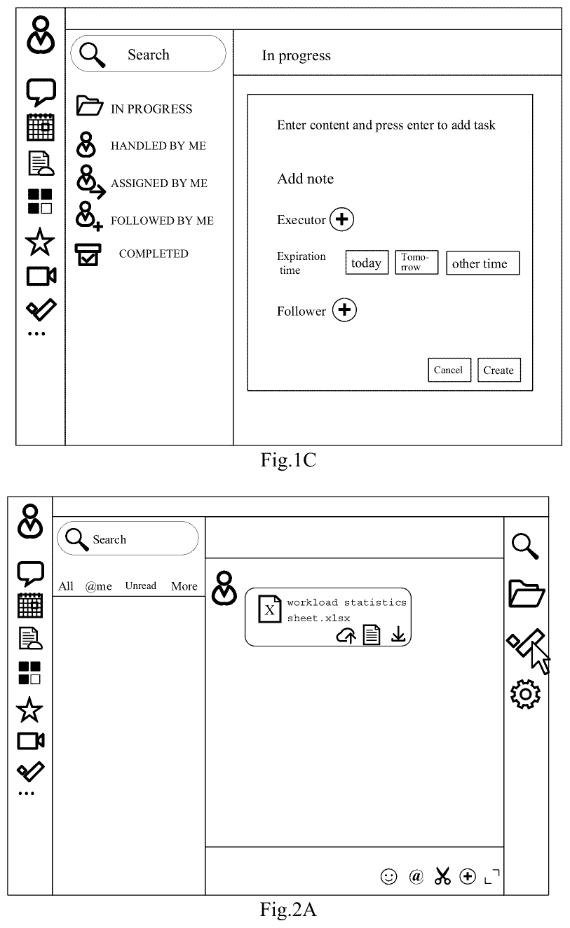

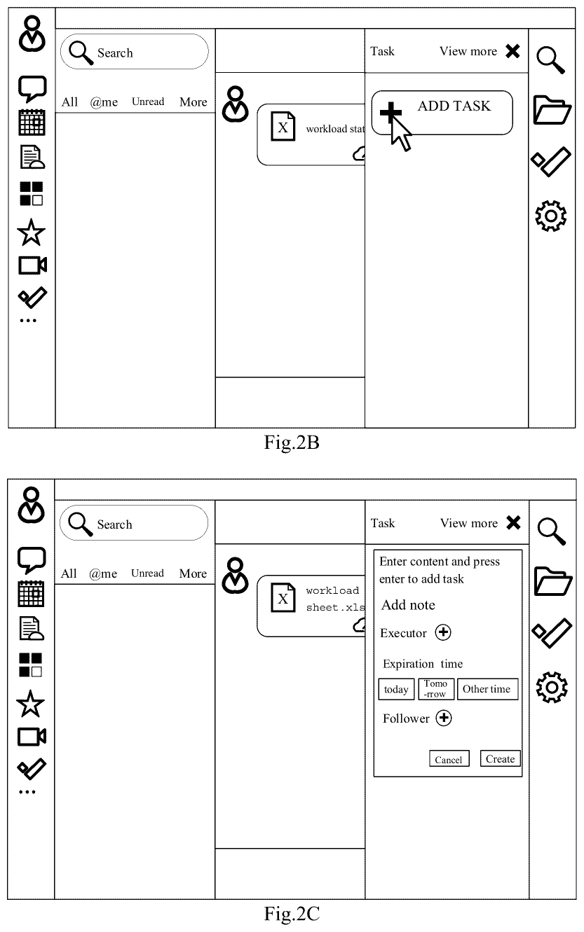

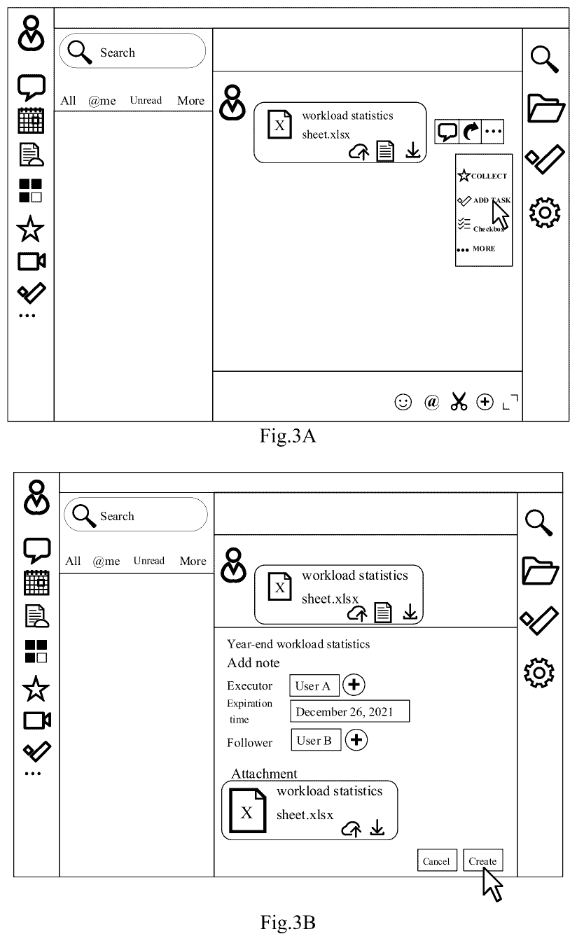

In the present disclosure, it is possible to display a task management page by triggering a Task control within instant messaging software, and display a task creation panel by triggering an ADD TASK control in the task management page, as shown in FIGS. 1A to 1C. Alternatively, it is possible to display a task management popup by triggering a Task control displayed in a session interface, and display a task creation panel by triggering an ADD TASK control in the task management popup, as shown in FIGS. 2A to 2C. Alternatively, it is possible to display a task creation panel by triggering an ADD TASK control in an action bar for session content, as shown in FIGS. 3A and 3B. Alternatively, it is also possible to display a task creation panel by triggering a control within another application, to enable cross-application task addition; specific limitations are not imposed on the manner of triggering displaying the task creation panel in the present disclosure.

FIGS. 1A to 1C, FIGS. 2A to 2C, FIGS. 3A to 3B, FIGS. 5A to 5C, FIGS. 11A to 11B, FIGS. 14A to 14B, and FIGS. 16A to 16B in the present disclosure only illustrate an interface for creating a task, but do not limit a position of each display box in the interface for creating a task and a proportion thereof in the entire interface.

In the technical solution of the present disclosure, by acquiring a trigger operation of a user on a target task in a task catalog, wherein the target task has a target attachment; and in response to the trigger operation, displaying, on the basis of a permission of the user, a task viewing panel corresponding to the target task, wherein the task viewing panel has a first presentation style and a second presentation style regarding the target attachment, and the displaying, on the basis of the permission of the user, the task viewing panel corresponding to the target task comprises: displaying the task viewing panel on the basis of the permission of the user and by means of the first presentation style or the second presentation style, the attachment in the task can be presented to the user on the basis of the permission of the user, making it convenient for the user to quickly read content of the attachment while controlling the permission of the task attachment.

The technical solution of the present disclosure is described in detail below with several specific embodiments.

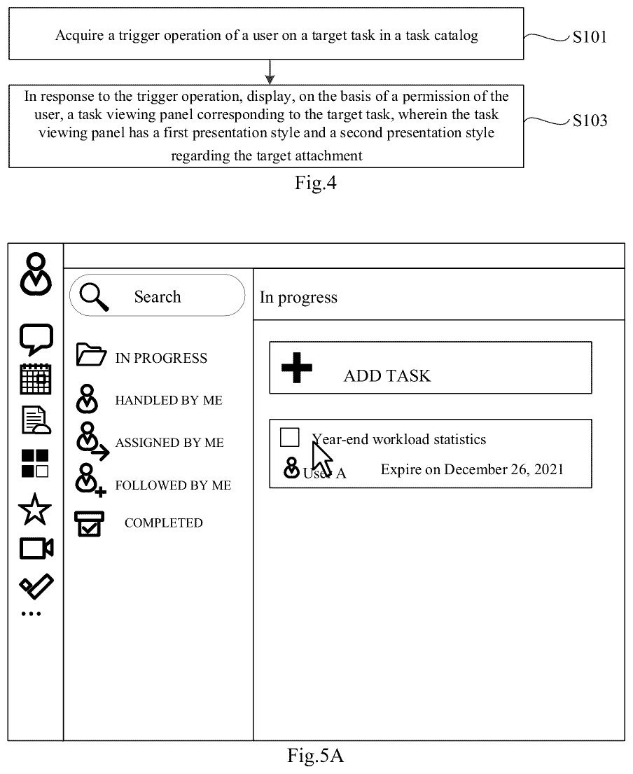

FIG. 4 is a schematic flow diagram of a task creation method provided by the present disclosure, as shown in FIG. 4, including:
S101, acquiring a trigger operation of a user on a target task in a task catalog.

The target task has a target attachment.

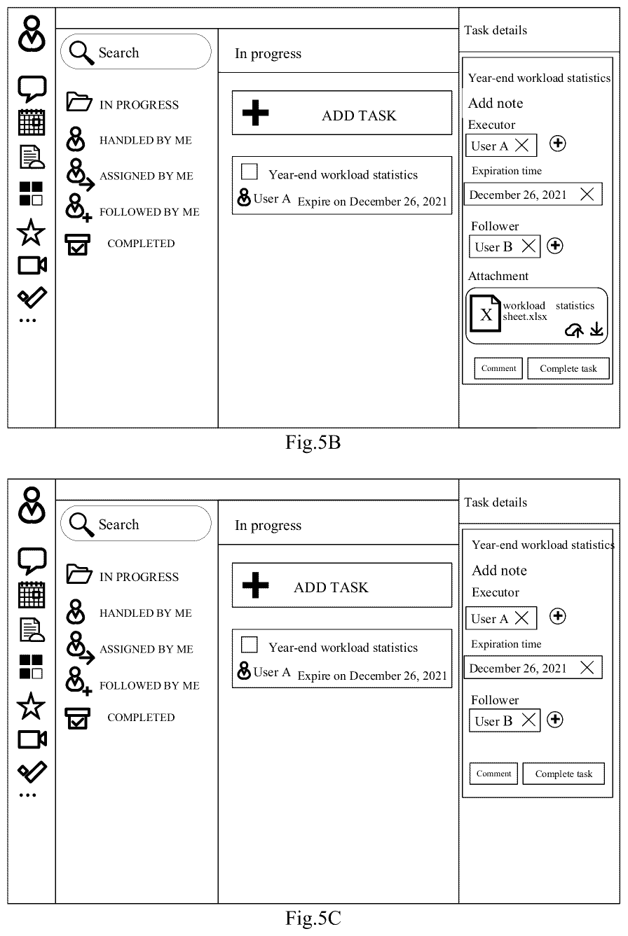

Exemplarily, a plurality of task catalogs can be displayed in the task management page, as shown in FIG. 5A, the task catalogs in the task management page including: IN PROGRESS, HANDLED BY ME, ASSIGNED BY ME, FOLLOWED BY ME, and COMPLETED. By triggering any of the plurality of task catalogs, all tasks in that task catalog can be presented, from which a task is selected as the target task, for example, as shown in FIG. 5A, the user triggers the IN PROGRESS task catalog, all tasks in progress are presented, and a task with a task name of “year-end workload statistics” is selected as a target task.

The target task includes a target attachment, for example, the target task “year-end workload statistics” includes a target attachment of “workload statistics sheet”.

S103, in response to the trigger operation, displaying, on the basis of a permission of the user, a task viewing panel corresponding to the target task, wherein the task viewing panel has a first presentation style and a second presentation style regarding the target attachment, and the displaying, on the basis of the permission of the user, the task viewing panel corresponding to the target task comprises: displaying the task viewing panel on the basis of the permission of the user and by means of the first presentation style or the second presentation style.

In some embodiments, the task viewing panel displays the target attachment in the first presentation style, and does not display the target attachment in the second presentation style.

However, those skilled in the art will readily appreciate that the present application is not limited to this. For example, in some embodiments, the task viewing panel displays the target attachment in both the first presentation style and the second presentation style, but with different ranges of content displayed.

In response to the trigger operation of the user on the target task, the task viewing panel is displayed, as shown in FIGS. 5B and 5C. Exemplarily, based on the above embodiment, if the user triggering the target task has a permission to view the target attachment “workload statistics sheet”, the task viewing panel displays the target attachment “workload statistics sheet”, as shown in FIG. 5B; if the user triggering the target task does not have the permission to view the target attachment “workload statistics sheet”, the task viewing panel does not display the target attachment, as shown in FIG. 5C, so that the control of the permission for the target attachment in the target task is realized.

In response to the user having the permission to view the target attachment “workload statistical sheet”, the user can directly open the target attachment “workload statistical sheet” by triggering the attachment, making it convenient for the user to read content of the attachment.

In this embodiment, by acquiring a trigger operation of a user on a target task in a task catalog, wherein the target task has a target attachment; and in response to the trigger operation, displaying a task viewing panel corresponding to the target task on the basis of a permission of the user, wherein the task viewing panel has a first presentation style and a second presentation style regarding the target attachment, and the displaying, on the basis of the permission of the user, the task viewing panel corresponding to the target task comprises: displaying the task viewing panel on the basis of the permission of the user and by means of the first presentation style or the second presentation style, the attachment in the task can be presented to the user on the basis of the permission of the user, making it convenient for the user to quickly read content of the attachment while controlling the permission of the task attachment.

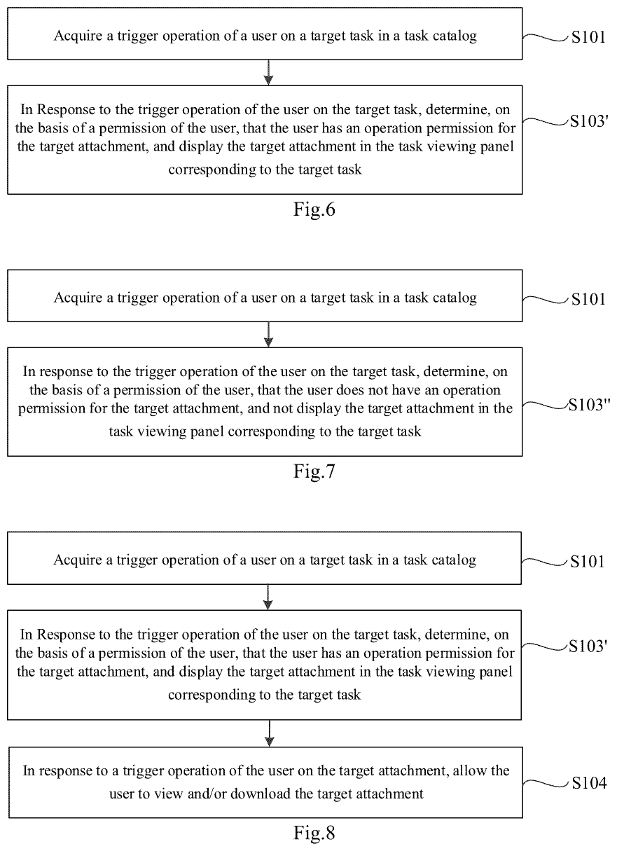

FIG. 6 is a schematic flow diagram of another task creation method provided by the present disclosure, and FIG. 6 is, based on the embodiment shown in FIG. 4, a specific description of a possible implementation for executing the $103, as follows:

S103′, in response to the trigger operation of the user on the target task, determining, on the basis of the permission of the user, that the user has an operation permission for the target attachment, and displaying the target attachment in the task viewing panel corresponding to the target task.

The operation permission of the user for the target attachment may be a read permission or a write permission of the user for the target attachment, and in response to the user triggering the target task, if the user has the read permission for the target attachment, the target attachment is displayed in the task viewing panel of the user, as shown in FIG. 5B, so that the user may view and/or download the target attachment. In response to the user triggering the target task, if the user has the write permission for the target attachment, the target attachment is also displayed in the task viewing panel of the user, as shown in FIG. 5B, so that the user can view, download and delete the target attachment.

FIG. 7 is a schematic flow diagram of yet another task creation method provided by the present disclosure, and FIG. 7 is, based on the embodiment shown in FIG. 4, a specific description of another possible implementation for executing the S103, as follows:

S103″, in response to the trigger operation of the user on the target task, determining, on the basis of the permission of the user, that the user does not have an operation permission for the target attachment, and not displaying the target attachment in the task viewing panel corresponding to the target task.

The operation permission of the user for the target attachment may be a read permission or a write permission of the user for the target attachment, and in response to the user triggering the target task, if the user does not have the read permission for the target attachment, the target attachment is not displayed in the task viewing panel of the user, as shown in FIG. 5C, so that the user cannot view and/or download the target attachment. In response to the user triggering the target task, if the user does not have the write permission for the target attachment, the target attachment is not displayed in the task viewing panel of the user either, as shown in FIG. 5C, so that the user cannot view, download, or delete the target attachment.

FIG. 8 is a schematic flow diagram of yet another task creation method provided by the present disclosure, and FIG. 8, based on the embodiment shown in FIG. 6, further includes:
S104, in response to a trigger operation of the user on the target attachment, allowing the user to view and/or download the target attachment.

Exemplarily, if the operation permission of the user for the target attachment is a read permission of the user for the target attachment, the task viewing panel of the user displays the target attachment, the read permission including a view permission and/or a download permission, so that the user can download the target attachment and/or view the target attachment.

If the read permission includes the view permission, the user triggers a view operation for the target attachment, and in response to the trigger operation of the user on the target attachment, the target attachment is opened and content of the target attachment is displayed. If the read permission includes the download permission, the user triggers a download operation for the target attachment, and in response to the trigger operation of the user on the target attachment, the target attachment is downloaded to the local. If the read permission includes the view permission and the download permission, the user can trigger a view operation for the target attachment and also can trigger a download operation for the target attachment, and in response to the view operation of the user on the target attachment, the target attachment can be opened and the content of the target attachment can be displayed, and in response to the download operation of the user on the target attachment, the target attachment can be downloaded to the local.

In this embodiment, if the operation permission for the target attachment that the user has is a write permission, the user is allowed to view and/or download the target attachment in response to a trigger operation of the user on the target attachment, thereby controlling the view permission and download permission for the task attachment.

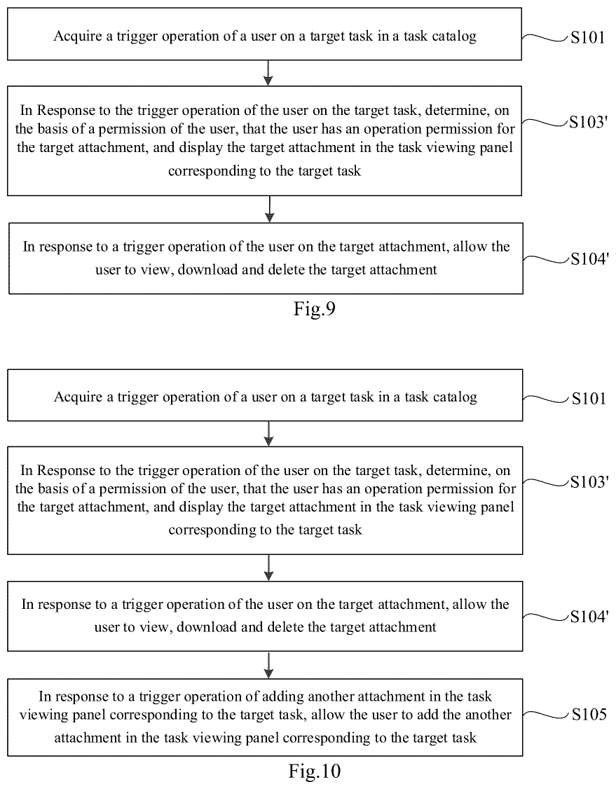

FIG. 9 is a schematic flow diagram of yet another task creation method provided by the present disclosure, and FIG. 9, based on the embodiment shown in FIG. 6, further includes:
S104′, in response to a trigger operation of the user on the target attachment, allowing the user to view, download and delete the target attachment.

Exemplarily, if the operation permission of the user for the target attachment is a write permission of the user for the target attachment, the target attachment is displayed on the task viewing panel corresponding to the user, the write permission including at least one of a view permission, a download permission, or a delete permission, so that the user may perform at least one of: downloading the target attachment, viewing the target attachment, or deleting the target attachment.

If the write permission includes the delete permission, the user triggers a deletion operation for the target attachment, and the target attachment is deleted in response to the user's trigger operation of deleting the target attachment. If the write permission includes the view permission, the user triggers a view operation for the target attachment, and the target attachment is opened and content of the target attachment is displayed in response to the user's trigger operation of viewing the target attachment. If the write permission includes the download permission, the user triggers a download operation for the target attachment, and the target attachment is downloaded to the local in response to the user's trigger operation of downloading the target attachment. If the write permission includes two/three of the view permission, the download permission and the delete permission, the user can trigger two/three corresponding operations of the deletion operation, the view operation and the download operation for the target attachment, and the corresponding operation can be executed in response to a single operation of the user on the target attachment.

In this embodiment, if the operation permission for the target attachment that the user has is a write permission, the user is allowed to view, download, and delete the target attachment in response to a trigger operation of the user on the target attachment, and the view permission, the download permission, and the delete permission for the task attachment can be individually controlled.

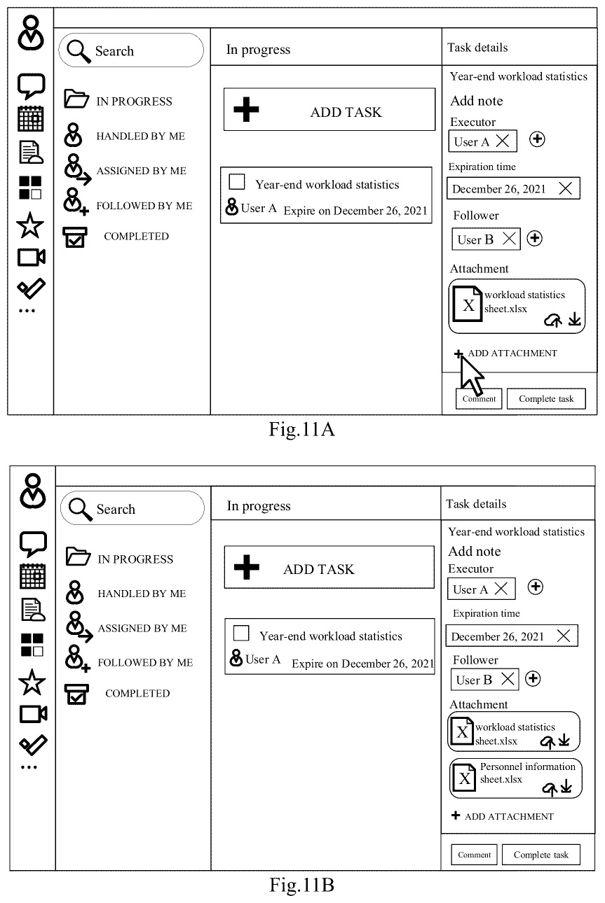

FIG. 10 is a schematic flow diagram of yet another task creation method provided by the present disclosure, and FIG. 10, based on the embodiment shown in FIG. 9, further includes:
S105, in response to a trigger operation of adding another attachment to the task viewing panel corresponding to the target task, allowing the user to add the another attachment to the task viewing panel corresponding to the target task.

FIG. 11A is a schematic diagram of yet another display screen provided by the present disclosure, where a user has a write permission for an attachment in a target task, and a target attachment is displayed in a task viewing panel of the user, as shown in FIG. 11A; in addition, an ADD ATTACHMENT control is also displayed in the task viewing panel.

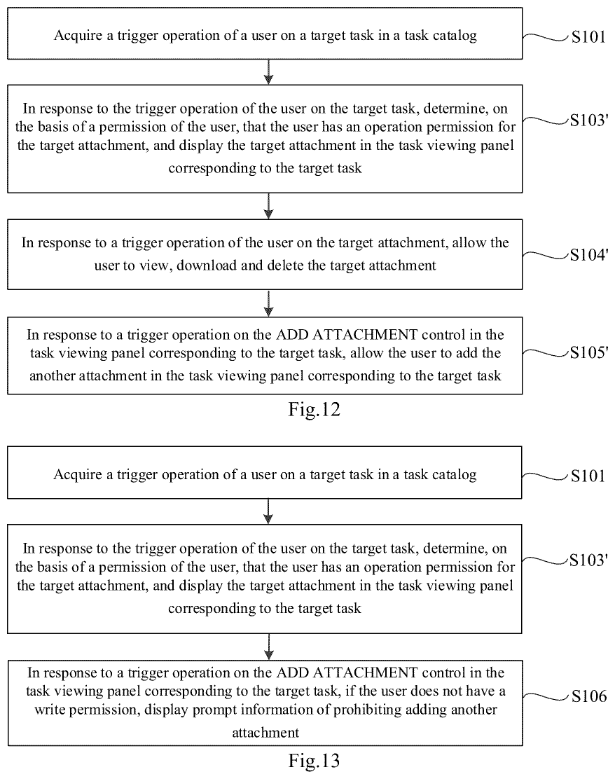

As a specific description of a possible implementation for performing the S105, as shown in FIG. 12:
S105′, in response to a trigger operation on the ADD ATTACHMENT control in the task viewing panel corresponding to the target task, allowing the user to add the another attachment to the task viewing panel corresponding to the target task.

FIG. 11B is a schematic diagram of yet another display screen provided by the present disclosure. If the target attachment is displayed in the task viewing panel, as shown in FIG. 11A, by clicking the ADD ATTACHMENT control, an operation of adding another attachment may be triggered in the task viewing panel, for example, another attachment is a sheet file named “personnel information sheet”, and in response to a trigger operation of adding another attachment to the task viewing panel, the “personnel information sheet” is added to the target task, so that the attachments of the “workload statistics sheet” and the “personnel information sheet” are displayed in the task viewing panel, as shown in FIG. 11B.

In this embodiment, in response to a trigger operation of adding another attachment to the task viewing panel corresponding to the target task, the user is allowed to add the another attachment to the task viewing panel, and an attachment can be continuously added to the target task, enabling a number of addition of an attachment to the target task.

FIG. 13 is a schematic flow diagram of yet another task creation method provided by the present disclosure, and FIG. 13, based on the embodiment shown in FIG. 6, further includes:
S106, in response to a trigger operation on the ADD ATTACHMENT control in the task viewing panel corresponding to the target task, if the user does not have a write permission, displaying prompt information of prohibiting adding another attachment.

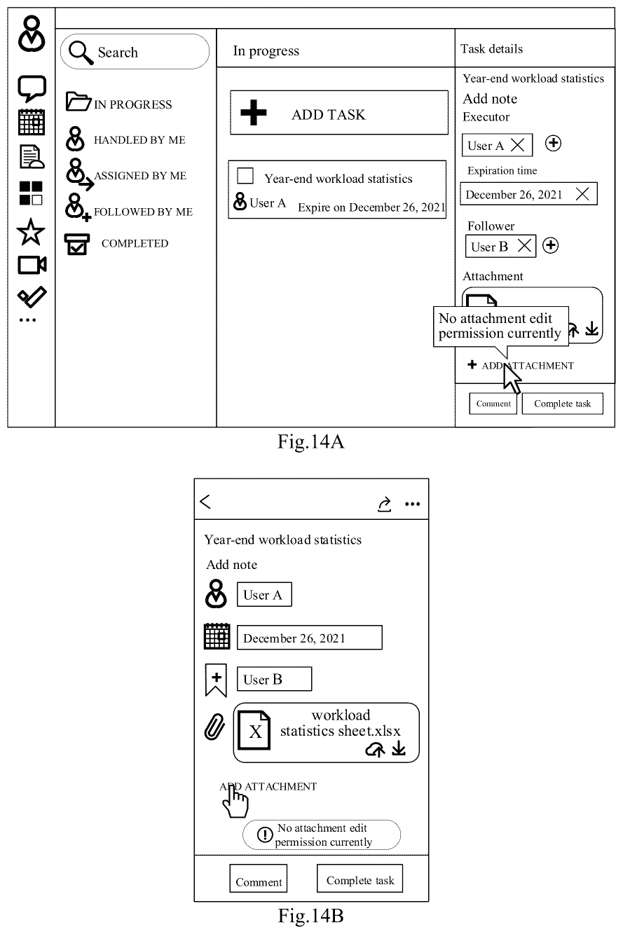

FIG. 14A is a schematic diagram of yet another display screen provided by the present disclosure, and FIG. 14B is a schematic diagram of yet another display screen provided by the present disclosure. Exemplarily, if a user has a read permission but does not have a write permission, a target attachment may still be displayed in a task viewing panel on a computer side, but when the user moves a cursor to an area near the ADD ATTACHMENT control in the task viewing panel, a prompt information box pops up, which displays prompt information of prohibiting adding another attachment, as shown in FIG. 14A. For example, the prompt information of prohibiting adding another attachment may be “no attachment edit permission currently”, as shown in FIG. 14A.

Exemplarily, if a user has a read permission but does not have a write permission, a target attachment may still be displayed in a task viewing panel of a mobile terminal by the user, but when the user clicks an ADD ATTACHMENT control in the task viewing panel, a prompt information box pops up in the task viewing panel, and the prompt information box displays prompt information of prohibiting adding another attachment, as shown in FIG. 14B, and the prompt information box may disappear after a preset time. For example, the prompt information of prohibiting adding another attachment may be displayed as “no attachment edit permission currently” as shown in FIG. 14B.

In this embodiment, in response to a trigger operation on the ADD ATTACHMENT control in the task viewing panel corresponding to the target task, if the user does not have a write permission, prompt information of prohibiting adding another attachment is displayed, which can prompt an operation permission of the user for adding another attachment, and avoids an invalid operation of the user.

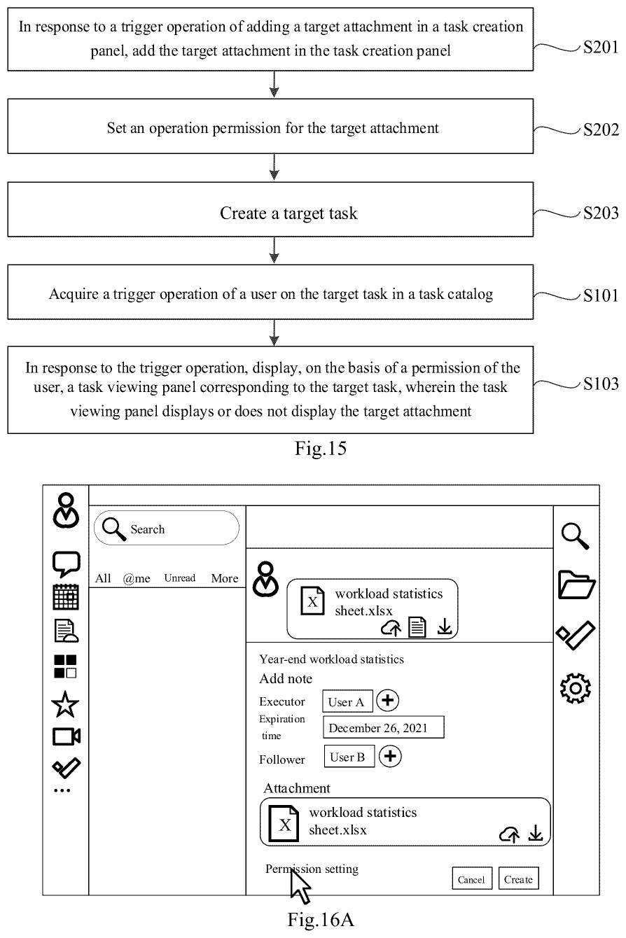

FIG. 15 is a schematic flow diagram of yet another task creation method provided by the present disclosure, and FIG. 15, based on the embodiment shown in FIG. 4, before the S101 is executed, further includes:
S201, in response to a trigger operation of adding a target attachment in a task creation panel, adding the target attachment in the task creation panel.

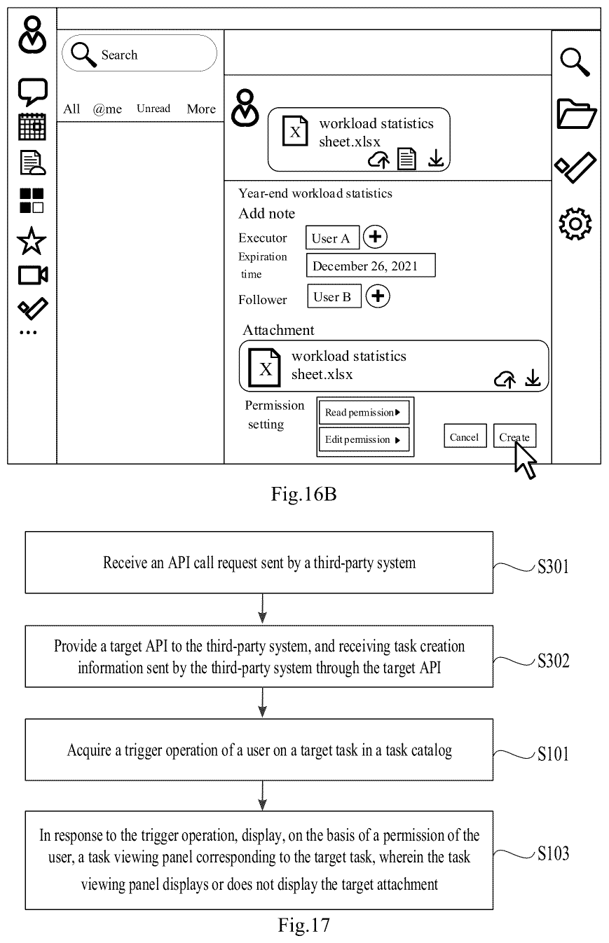

FIG. 16A is a schematic diagram of yet another display screen provided by the present disclosure, and as shown in FIG. 16A, a task creation panel may include a task name bar, a task note bar, an EXECUTOR ADDITION control, an ADD ATTACHMENT control, an EXPIRATION TIME SETTING control, a FOLLOWER ADDITION control, and the like. A PERMISSION SETTING control, a PROMPT SETTING control and the like can also be included.

A task name may be entered in the task name bar, for example, as shown in FIG. 3B, a name of a target task entered in the task name bar is “year-end workload statistics”. In the task note bar, note information for the task may be entered, and in response to a trigger on the EXECUTOR ADDITION control/FOLLOWER ADDITION control, a personnel list may be displayed, from which an executor/follower of the task may be selected, for example, as shown in FIG. 3B, the set executor is a user A, and the set follower is a user B. In response to a trigger for the EXPIRATION TIME SETTING control, a time setting table is displayed, from which a date and/or time point when the task expires is selected, for example, as shown in FIG. 3B, the set expiration time is Dec. 26, 2021. In response to a trigger for the ADD ATTACHMENT control, a target attachment may be added to the target task, for example, as shown in FIG. 3B, the added target attachment is a sheet file with a file name of “workload statistics sheet”.

It should be noted that, if session content is a file, by triggering an ADD TASK control in an action bar for the session content, the file is added as a target attachment to a target task by default in the displayed task creation panel. For example, as shown in FIG. 3A, the session content is a sheet file with a file name of “workload statistics sheet”, and by triggering the ADD TASK control in the action bar of the session content, the “workload statistics sheet” is added as a target attachment to the target task by default in the task creation panel, as shown in FIG. 3B.

S202, setting an operation permission for the target attachment.

FIG. 16A is a schematic diagram of yet another display screen provided by the present disclosure, FIG. 16B is a schematic diagram of yet another display screen provided by the present disclosure, where a PERMISSION SETTING control is also displayed in the task creation panel, as shown in FIG. 16A. In response to a trigger on the PERMISSION SETTING control, permission options are displayed. Exemplarily, as shown in FIG. 16B, the permission options may include a read permission option and an edit permission option, and a person with a read permission may be set for the read permission option, and a person with an edit permission may be set for the edit permission option. The person with the read permission can have a target attachment displayed in his own task viewing panel and can download and view the target attachment, and the person with the edit permission can also have a target attachment displayed in his own task viewing panel, and can download, view and edit the target attachment.

S203, creating a target task.

After the setting of the operation permission is completed for the target attachment, as shown in FIG. 16B, by triggering a CREATE button, the target task can be created so that the attachment in the target task can be displayed in a task viewing panel of a specified user and operated by the specified user. For example, as shown in FIG. 16B, a participant of the target task is a user A, then a task management page displayed on a client of the user A is as shown in FIG. 5A.

In this embodiment, in response to a trigger operation of adding a target attachment in a task creation panel, the target attachment is added in the task creation panel; an operation permission for the target attachment is set; and a target task is created, so that the attachment can be added when the task is created.

FIG. 17 is a schematic flow diagram of yet another task creation method provided by the present disclosure, and FIG. 17, based on the embodiment shown in FIG. 4, before the S101 is executed, further includes:
S301, receiving an API call request sent by a third-party system.

The API call request is configured for requesting calling a target API.

Exemplarily, the above embodiment is executed by an application 1, and an application programming interface (API) corresponding to the application 1 is a target API, where the API is some predefined functions, for the purpose of providing capabilities of an application and developers accessing a set of routines based on certain software or hardware, without accessing source code or understanding details of an internal working mechanism. Before accessing the application 1, an application 2 needs to send a request for calling the target API to the application 1, to establish a communication connection between the application 2 and the application 1.

The request for calling the target API, i.e. the API call request, may be packaged as one touch key, which is displayed in the application 2, so that the user sends the API call request to the application 1 by triggering the touch key in the application 2. The API call request may also be a string of command characters entered by the user, so that the user sends the API call request to the application 1 by entering a specific command character string in the application 2.

S302, providing a target API to the third-party system, and receiving task creation information sent by the third-party system through the target API.

The task creation information includes: data of a target attachment and operation permission information of the target attachment.

Exemplarily, based on the above embodiment, after receiving the API call request, the application 1 responds to the API call request, so that the application 2 establishes a communication connection with the application 1 by calling the target API. The user can, in the application 2, set task creation information such as a task name information, task note information, content of a target attachment, operation permission information of the target attachment, and task expiration time information. The application 2 sends the set task creation information to the application 1 through the target API, and based on the received task creation information, the application 1 creates, in the application 1, a target task, which includes the target attachment, the task name, the task note, the operation permission for the target attachment, the task expiration time and the like.

In this embodiment, by receiving an API call request sent by a third-party system, which is configured for requesting calling a target API; providing the target API to the third-party system, and receiving task creation information sent by the third-party system through the target API, which includes: data of a target attachment and operation permission information of the target attachment, cross-application task creation can be enabled under the condition that the third-party system does not need to download an application of the task system, and quick upload of a single attachment or batch attachments and setting of the permission for the attachment can be enabled, making it convenient for a user to use.

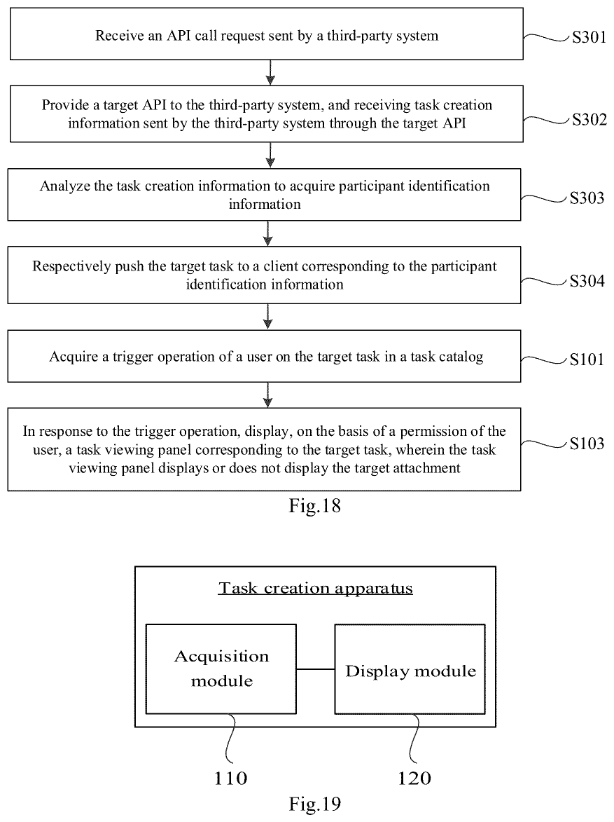

FIG. 18 is a schematic flow diagram of yet another task creation method provided by the present disclosure, and FIG. 18, based on the embodiment shown in FIG. 17, further includes:
S303, analyzing the task creation information to acquire participant identification information.

The task creation information further includes participant identification information, which may be at least one of an executor, a follower, or a manager of the task. Exemplarily, based on the above embodiment, the application 1 analyzes the received task creation information, and may acquire the participant identification information of the task.

S304, respectively pushing the target task to a client corresponding to the participant identification information.

The target task has the target attachment.

Exemplarily, based on the above embodiment, the application 1 sends the created target task to a client corresponding to the participant identification information. For example, the task creation information includes identification information of a participant A, and the target task is sent to a client corresponding to the participant A, so that the client corresponding to the participant A can display the target task, and display a target attachment in the target task or not on the basis of a permission of the participant A for the target attachment.

In this embodiment, the task creation information further includes: participant identification information, and by analyzing the task creation information, the participant identification information is acquired; and the target task is respectively pushed to a client corresponding to the participant identification information, the target task having the target attachment, so that the target task is only pushed to the participant of the target task, and other persons cannot view the target task, thereby improving privacy of the target task.

An embodiment of the present disclosure further provides a task creation apparatus, and FIG. 19 is a schematic structural diagram of a task creation apparatus provided by the present disclosure, as shown in FIG. 19, the task creation apparatus comprising:
an acquisition module 110 configured to acquire a trigger operation of a user on a target task in a task catalog, wherein the target task has a target attachment;
a display module 120 configured to, in response to the trigger operation, display, on the basis of a permission of the user, a task viewing panel corresponding to the target task; wherein the task viewing panel has a first presentation style and a second presentation style regarding the target attachment, and the displaying, on the basis of the permission of the user, the task viewing panel corresponding to the target task comprises: displaying the task viewing panel on the basis of the permission of the user and by means of the first presentation style or the second presentation style.

Optionally, the task viewing panel displays the target attachment in the first presentation style; and the task viewing panel does not display the target attachment in the second presentation style.

Optionally, the display module 120 is further configured to, in response to the trigger operation of the user on the target task, determine, on the basis of the permission of the user, that the user has an operation permission for the target attachment, and display the target attachment in the task viewing panel corresponding to the target task.

Optionally, if the operation permission for the target attachment that the user has is a read permission, the task creation apparatus further comprises:
a determination module configured to, in response to a trigger operation of the user on the target attachment, allow the user to view and/or download the target attachment.

Optionally, if the operation permission for the target attachment that the user has is a write permission, the task creation apparatus further comprises:
a determination module configured to, in response to a trigger operation of the user on the target attachment, allow the user to view, download and delete the target attachment.

Optionally, the determination module is further configured to, in response to a trigger operation of adding another attachment to the task viewing panel corresponding to the target task, allow the user to add the another attachment to the task viewing panel corresponding to the target task.

Optionally, the task viewing panel corresponding to the target task displays an ADD ATTACHMENT control.

The determination module is further configured to, in response to a trigger operation on the ADD ATTACHMENT control in the task viewing panel corresponding to the target task, allow the user to add the another attachment to the task viewing panel corresponding to the target task.

Optionally, the task viewing panel corresponding to the target task displays an ADD ATTACHMENT control.

The display module 120 is further configured to, in response to a trigger operation on the ADD ATTACHMENT control in the task viewing panel corresponding to the target task, if the user does not have a write permission, display prompt information of prohibiting adding another attachment.

Optionally, the display module 120 is further configured to, in response to the trigger operation of the user on the target task, determine, on the basis of the permission of the user, that the user does not have an operation permission for the target attachment, and not display the target attachment in the task viewing panel corresponding to the target task.

Optionally, the task creation apparatus further comprises: a creation module configured to, in response to a trigger operation of adding a target attachment in a task creation panel, add the target attachment in the task creation panel; set an operation permission for the target attachment; and create the target task.

Optionally, the task creation apparatus further comprises:
a receiving module configured to receive an API call request sent by a third-party system, the API call request being configured for requesting calling a target API;
a sending module configured to provide the target API to the third-party system; wherein
the receiving module is further configured to receive task creation information sent by the third-party system through the target API, the task creation information comprising: data of a target attachment and operation permission information of the target attachment.

Optionally, the task creation information further comprises: participant identification information.

The acquisition module 110 is further configured to analyze the task creation information to acquire the participant identification information.

The sending module is further configured to respectively push the target task to a client corresponding to the participant identification information, the target task having the target attachment.

The apparatus provided by the embodiment of the present disclosure can execute the method provided by any embodiment of the present disclosure, and has the corresponding functional modules and beneficial effects of executing the method, which are not repeated herein.

The present disclosure provides an electronic device, comprising: a processor for executing a computer program stored in a memory, the processor, when executing the computer program, implementing steps of any of the method embodiments described above.

The present disclosure provides a computer-readable storage medium having thereon stored a computer program which, when executed by a processor, implements steps of any of the method embodiments described above.

The present disclosure provides a computer program product which, when running on a computer, causes the computer to perform steps of any of the method embodiments described above.

The present disclosure provides a computer program comprising instructions which, when executed by a processor, cause the processor to perform steps of any of the method embodiments described above.

In a first aspect, the present disclosure provides a task creation method, comprising:
acquiring a trigger operation of a user on a target task in a task catalog, wherein the target task has a target attachment; and
in response to the trigger operation, displaying, on the basis of a permission of the user, a task viewing panel corresponding to the target task, wherein the task viewing panel has a first presentation style and a second presentation style regarding the target attachment, and the displaying, on the basis of the permission of the user, the task viewing panel comprises: displaying the task viewing panel on the basis of the permission of the user and by means of the first presentation style or the second presentation style.

Optionally, the task viewing panel displays the target attachment in the first presentation style; and the task viewing panel does not display the target attachment in the second presentation style.

Optionally, the displaying, in response to the trigger operation, on the basis of the permission of the user, the task viewing panel corresponding to the target task comprises:
in response to the trigger operation of the user on the target task, determining, on the basis of the permission of the user, that the user has an operation permission for the target attachment, and displaying the target attachment in the task viewing panel corresponding to the target task.

Optionally, if the operation permission for the target attachment that the user has is a read permission, the method further comprises:
in response to a trigger operation of the user on the target attachment, allowing the user to view and/or download the target attachment.

Optionally, if the operation permission for the target attachment that the user has is a write permission, the method further comprises:
in response to a trigger operation of the user on the target attachment, allowing the user to view, download and delete the target attachment.

Optionally, the method further comprises:
in response to a trigger operation of adding another attachment to the task viewing panel corresponding to the target task, allowing the user to add the another attachment to the task viewing panel corresponding to the target task.

Optionally, the task viewing panel corresponding to the target task displays an ADD ATTACHMENT control; and
the in response to the trigger operation of adding another attachment to the task viewing panel corresponding to the target task, allowing the user to add the another attachment to the task viewing panel corresponding to the target task comprises:
in response to a trigger operation on the ADD ATTACHMENT control in the task viewing panel corresponding to the target task, allowing the user to add the another attachment to the task viewing panel corresponding to the target task.

Optionally, the task viewing panel corresponding to the target task displays an ADD ATTACHMENT control; and
the method further comprises:
in response to a trigger operation on the ADD ATTACHMENT control in the task viewing panel corresponding to the target task, if the user does not have a write permission, displaying prompt information of prohibiting adding another attachment.

Optionally, the displaying, in response to the trigger operation, on the basis of the permission of the user, the task viewing panel corresponding to the target task comprises:
in response to the trigger operation of the user on the target task, determining, on the basis of the permission of the user, that the user does not have an operation permission for the target attachment, and not displaying the target attachment in the task viewing panel corresponding to the target task.

Optionally, before the acquiring the trigger operation of the user on the target task in the task catalog, the method further comprises:
in response to a trigger operation of adding a target attachment in a task creation panel, adding the target attachment in the task creation panel;
setting an operation permission for the target attachment; and
creating the target task.

Optionally, before the acquiring the trigger operation of the user on the target task in the task catalog, the method further comprises:
receiving an API call request sent by a third-party system, the API call request being configured for requesting calling a target API; and
providing the target API to the third-party system, and receiving task creation information sent by the third-party system through the target API, the task creation information comprising: data of a target attachment and operation permission information of the target attachment.

Optionally, the task creation information further comprises: participant identification information; and
the method further comprises:
analyzing the task creation information to acquire the participant identification information; and
respectively pushing the target task to a client corresponding to the participant identification information, the target task having the target attachment.

In a second aspect, an embodiment of the present disclosure provides a task creation apparatus, comprising:
an acquisition module configured to acquire a trigger operation of a user on a target task in a task catalog, wherein the target task has a target attachment;
a display module configured to, in response to the trigger operation, display, on the basis of a permission of the user, a task viewing panel corresponding to the target task, wherein the task viewing panel has a first presentation style and a second presentation style regarding the target attachment, and the displaying, on the basis of the permission of the user, the task viewing panel corresponding to the target task comprises: displaying the task viewing panel on the basis of the permission of the user and by means of the first presentation style or the second presentation style.

Optionally, the task viewing panel displays the target attachment in the first presentation style; and the task viewing panel does not display the target attachment in the second presentation style.

Optionally, the display module is further configured to, in response to the trigger operation of the user on the target task, determine, on the basis of the permission of the user, that the user has an operation permission for the target attachment, and display the target attachment in the task viewing panel corresponding to the target task.

Optionally, if the operation permission for the target attachment that the user has is a read permission, the task creation apparatus further comprises:
a determination module configured to, in response to a trigger operation of the user on the target attachment, allow the user to view and/or download the target attachment.

Optionally, if the operation permission for the target attachment that the user has is a write permission, the task creation apparatus further comprises:
a determination module configured to, in response to a trigger operation of the user on the target attachment, allow the user to view, download and delete the target attachment.

Optionally, the determination module is further configured to, in response to a trigger operation of adding another attachment to the task viewing panel corresponding to the target task, allow the user to add the another attachment to the task viewing panel corresponding to the target task.

Optionally, the task viewing panel corresponding to the target task displays an ADD ATTACHMENT control.

The determination module is further configured to, in response to a trigger operation on the ADD ATTACHMENT control in the task viewing panel corresponding to the target task, allow the user to add the another attachment to the task viewing panel corresponding to the target task.

Optionally, the task viewing panel corresponding to the target task displays an ADD ATTACHMENT control.

The display module is further configured to, in response to a trigger operation on the ADD ATTACHMENT control in the task viewing panel corresponding to the target task, if the user does not have a write permission, display prompt information of prohibiting adding another attachment.

Optionally, the display module is further configured to, in response to the trigger operation of the user on the target task, determine, on the basis of the permission of the user, that the user does not have an operation permission for the target attachment, and not display the target attachment in the task viewing panel corresponding to the target task.

Optionally, the task creation apparatus further comprises:
a creation module configured to, in response to a trigger operation of adding a target attachment in a task creation panel, add the target attachment in the task creation panel; set an operation permission for the target attachment; and create the target task.

Optionally, the task creation apparatus further comprises:
a receiving module configured to receive an API call request sent by a third-party system, the API call request being configured for requesting calling a target API;
a sending module configured to provide the target API to the third-party system.

The receiving module is further configured to receive task creation information sent by the third-party system through the target API, the task creation information comprising: data of a target attachment and operation permission information of the target attachment.

Optionally, the task creation information further comprises: participant identification information.

The acquisition module is further configured to analyze the task creation information to acquire the participant identification information.

The sending module is further configured to respectively push the target task to a client corresponding to the participant identification information, the target task having the target attachment.

In a third aspect, the present disclosure provides an electronic device, comprising: a processor configured to execute a computer program stored in a memory, the processor, when executing the computer program, implementing steps of any of the method embodiments described above.

In a fourth aspect, the present disclosure provides a computer-readable storage medium having thereon stored a computer program which, when executed by a processor, implements steps of any of the method embodiments described above.

In a fifth aspect, the present disclosure provides a computer program product which, when running on a computer, causes the computer to perform steps of any of the method embodiments described above. In a sixth aspect, an embodiment of the present disclosure further provides a computer program comprising instructions which, when executed by a processor, cause the processor to perform steps of any of the method embodiments described above.

It should be noted that, relational terms such as “first” and “second”, herein, are only used for distinguishing one entity or operation from another entity or operation without necessarily requiring or implying any such actual relation or order between these entities or operations. Moreover, the term “comprise”, “include”, or any other variation thereof, is intended to encompass a non-exclusive inclusion, such that a process, method, article, or device comprising a list of elements not only includes those elements but also includes other elements not expressly listed, or also includes elements inherent to such a process, method, article, or device. Without more limitations, an element defined by a statement “comprising a . . . ” does not exclude the presence of another identical element in the process, method, article, or device that includes the element.

The above only describes specific implementations of the present disclosure, which enable those skilled in the art to understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to these embodiments described herein, but conform to the widest scope consistent with the principles and novel features disclosed herein.

What is claimed is:

1. A task creation method, comprising:
acquiring a trigger operation of a user on a target task in a task catalog, wherein the target task has a target attachment; and
in response to the trigger operation, displaying, on the basis of a permission of the user, a task viewing panel corresponding to the target task, wherein the task viewing panel has a first presentation style and a second presentation style regarding the target attachment, and the displaying, on the basis of the permission of the user, the task viewing panel corresponding to the target task comprises: displaying the task viewing panel on the basis of the permission of the user and by means of the first presentation style or the second presentation style.

2. The method according to claim 1, wherein
the task viewing panel displays the target attachment in the first presentation style; and
the task viewing panel does not display the target attachment in the second presentation style.

3. The method according to claim 2, wherein the displaying, in response to the trigger operation, on the basis of the permission of the user, the task viewing panel corresponding to the target task comprises:
in response to the trigger operation of the user on the target task, determining, on the basis of the permission of the user, that the user has an operation permission for the target attachment, and displaying the target attachment in the task viewing panel corresponding to the target task.

4. The method according to claim 3, wherein if the operation permission for the target attachment that the user has is a read permission, the method further comprises:
in response to a trigger operation of the user on the target attachment, allowing the user to view and/or download the target attachment.

5. The method according to claim 3, wherein if the operation permission for the target attachment that the user has is a write permission, the method further comprises:
in response to a trigger operation of the user on the target attachment, allowing the user to view, download and delete the target attachment.

6. The method according to claim 3, wherein if the operation permission for the target attachment that the user has is a write permission, the method further comprises:
in response to a trigger operation of adding another attachment to the task viewing panel corresponding to the target task, allowing the user to add the another attachment to the task viewing panel corresponding to the target task.

7. The method according to claim 6, wherein the task viewing panel corresponding to the target task displays an ADD ATTACHMENT control; and
the in response to the trigger operation of adding another attachment to the task viewing panel corresponding to the target task, allowing the user to add the another attachment to the task viewing panel corresponding to the target task, comprises:
in response to a trigger operation on the ADD ATTACHMENT control in the task viewing panel corresponding to the target task, allowing the user to add the another attachment to the task viewing panel corresponding to the target task.

8. The method according to claim 3, wherein the task viewing panel corresponding to the target task displays an ADD ATTACHMENT control; and
the method further comprises:
in response to a trigger operation on the ADD ATTACHMENT control in the task viewing panel corresponding to the target task, if the user does not have a write permission, displaying prompt information of prohibiting adding another attachment.

9. The method according to claim 2, wherein the displaying, in response to the trigger operation, on the basis of the permission of the user, the task viewing panel corresponding to the target task comprises:
in response to the trigger operation of the user on the target task, determining, on the basis of the permission of the user, that the user does not have an operation permission for the target attachment, and not displaying the target attachment in the task viewing panel corresponding to the target task.

10. The method according to claim 1, wherein before the acquiring the trigger operation of the user on the target task in the task catalog, the method further comprises:
in response to a trigger operation of adding a target attachment in a task creation panel, adding the target attachment in the task creation panel;
setting an operation permission for the target attachment; and
creating the target task.

11. The method according to claim 1, wherein before the acquiring the trigger operation of the user on the target task in the task catalog, the method further comprises:
receiving an application programming interface (API) call request sent by a third-party system, the API call request being configured for requesting calling a target API; and
providing the target API to the third-party system, and receiving task creation information sent by the third-party system through the target API, the task creation information comprising: data of a target attachment and operation permission information of the target attachment.

12. The method according to claim 11, wherein the task creation information further comprises: participant identification information; and
the method further comprises:
analyzing the task creation information to acquire the participant identification information; and
respectively pushing the target task to a client corresponding to the participant identification information, the target task having the target attachment.

13. An electronic device, comprising: a processor configured to execute a computer program stored in a memory, the computer program, when executed by the processor, implementing steps of a task creation method comprising:
acquiring a trigger operation of a user on a target task in a task catalog, wherein the target task has a target attachment; and
in response to the trigger operation, displaying, on the basis of a permission of the user, a task viewing panel corresponding to the target task, wherein the task viewing panel has a first presentation style and a second presentation style regarding the target attachment, and the displaying, on the basis of the permission of the user, the task viewing panel corresponding to the target task comprises: displaying the task viewing panel on the basis of the permission of the user and by means of the first presentation style or the second presentation style.

14. The electronic device according to claim 13, wherein:
the task viewing panel displays the target attachment in the first presentation style; and
the task viewing panel does not display the target attachment in the second presentation style.

15. The electronic device according to claim 14, wherein the displaying, in response to the trigger operation, on the basis of the permission of the user, the task viewing panel corresponding to the target task comprises:
in response to the trigger operation of the user on the target task, determining, on the basis of the permission of the user, that the user has an operation permission for the target attachment, and displaying the target attachment in the task viewing panel corresponding to the target task.

16. The electronic device according to claim 15, wherein if the operation permission for the target attachment that the user has is a read permission, the method further comprises:
in response to a trigger operation of the user on the target attachment, allowing the user to view and/or download the target attachment.

17. The electronic device according to claim 15, wherein if the operation permission for the target attachment that the user has is a write permission, the method further comprises:
in response to a trigger operation of the user on the target attachment, allowing the user to view, download and delete the target attachment.

18. The electronic device according to claim 15, wherein if the operation permission for the target attachment that the user has is a write permission, the method further comprises:
in response to a trigger operation of adding another attachment to the task viewing panel corresponding to the target task, allowing the user to add the another attachment to the task viewing panel corresponding to the target task.

19. The electronic device according to claim 18, wherein the task viewing panel corresponding to the target task displays an ADD ATTACHMENT control; and
the in response to the trigger operation of adding another attachment to the task viewing panel corresponding to the target task, allowing the user to add the another attachment to the task viewing panel corresponding to the target task, comprises:
in response to a trigger operation on the ADD ATTACHMENT control in the task viewing panel corresponding to the target task, allowing the user to add the another attachment to the task viewing panel corresponding to the target task.

20. A non-transitory computer-readable storage medium having thereon stored a computer program which, when executed by a processor, implements steps of a task creation method comprising:
acquiring a trigger operation of a user on a target task in a task catalog, wherein the target task has a target attachment; and
in response to the trigger operation, displaying, on the basis of a permission of the user, a task viewing panel corresponding to the target task, wherein the task viewing panel has a first presentation style and a second presentation style regarding the target attachment, and the displaying, on the basis of the permission of the user, the task viewing panel corresponding to the target task comprises: displaying the task viewing panel on the basis of the permission of the user and by means of the first presentation style or the second presentation style.
